(19) United States
(12) Patent Application Publication
(10) Pub. No.: US 2026/0311661 A1
(43) Pub. Date: Oct. 8, 2026

(54) GRAND PIANO FALLBOARD STOPPER

(71) Applicant: The Florida State University Research Foundation, Inc., Tallahassee, FL (US)

(72) Inventor: Jodie Karen Cheung, Tallahassee, FL (US)

(21) Appl. No.: 19/640,580

(22) Filed: Apr. 7, 2026

Related U.S. Application Data
(60) Provisional application No. 63/784,427, filed on Apr. 7, 2025.

(51) Int. Cl. G10C 3/02; G10C 1/04

(52) U.S. Cl. CPC G10C 3/02; G10C 1/04

(57) ABSTRACT

A stopper device for a piano fallboard includes a main body spanning between a first body end to a second body end spaced apart from the first body end along a longitudinal axis. The main body includes a fixed body side and a free end spaced apart from the fixed body side in a direction transverse to the longitudinal axis. The stopper device includes a curved tapered portion including the free end of the main body. The device includes a fastener strip extending from the fixed body side of the main body, the fastener strip being couplable to a fallboard of a piano. The stopper device hinders items from falling behind the fallboard and into the primary cavity of the piano.

### CROSS-REFERENCE TO RELATED APPLICATIONS

This application claims priority to and the benefit of U.S. Provisional Patent Application serial no. 63/784,427, filed Apr. 7, 2025, the entire contents of which are incorporated herein by reference.

### BACKGROUND

Pianos (e.g., grand pianos) are designed in a way where pencils and other items can easily slide into the piano but cannot be retrieved without taking the piano apart. This presents a problem because pianos should only be taken apart by a piano technician. Furthermore, the pencil or other item that falls into the piano can jam some of the moving parts in the piano and cause them to not work and/or break. Therefore, a need exists to prevent such items from falling into the piano.

### SUMMARY

According to one implementation, a stopper device for a piano fallboard is disclosed. The stopper device includes a main body spanning between a first body end and a second body end spaced apart from the first body end along a longitudinal axis. The main body includes a fixed body side and a free end spaced apart from the fixed body side in a direction transverse to the longitudinal axis. The main body further includes a curved tapered portion including the free end of the main body. The main body further includes a fastener strip extending from the fixed body side of the main body, the fastener strip being couplable to a fallboard of a piano.

In some implementations, a length of the main body is defined between the first body end and the second body end, the length of the main body being configured to extend across a length of the fallboard of the piano.

In some implementations, the main body further includes an upper body surface and a lower body surface opposed to the upper body surface, wherein a thickness of the main body is defined between the upper body surface and the lower body surface.

In some implementations, the curved tapered portion includes a thickness less than that of a remainder of the main body.

In some implementations, the curved tapered portion terminates in an edge at which the upper body surface converges with the lower body surface.

In some implementations, the lower body surface of the curved tapered portion is concave to define a stopper cavity.

In some implementations, the main body includes a flexible material capable of elastic deformation.

In some implementations, the stopper device further includes a channel defined along a length of the main body adjacent to the fixed body side, the channel splitting the main body into a first portion and a second portion coupled to each other via a hinge portion such that the first portion of the main body is moveable about the hinge portion relative to the second portion of the main body.

In some implementations, the fastener strip defines one or more holes configured to receive a fastener.

According to one implementation, an assembly is disclosed including a fallboard and a stopper device. The fallboard for a piano includes a back end, the fallboard being movable between an open position and a closed position to reveal or conceal, respectively, a keyboard of the piano. The stopper device includes a fastener strip coupled to the back end of the fallboard. The stopper device further includes a main body spanning a length of the fallboard in a longitudinal direction. The main body includes a fixed body side coupled to the fastener strip. The main body includes a free end spaced apart from the fixed body side in a direction transverse to the longitudinal direction. The main body further includes a curved tapered portion including the free end of the main body. When the fallboard moves between the open and closed positions, the stopper device moves between an open configuration and a closed configuration, respectively, such that the stopper device separates a primary cavity of the piano from an exterior of the piano to hinder objects from falling into the primary cavity behind the fallboard.

In some implementations, in the open configuration of the fallboard, the main body of the stopper device is disposed within the primary cavity of the piano, wherein the free end of the main body abuts a stretcher board or a pin block of the piano such that the main body is substantially perpendicular to the stretcher board or the pin block.

In some implementations, when moving the fallboard between the open and closed positions and the stopper device between the corresponding open and closed configurations, the curved tapered portion of the stopper device slides along a pin block and/or a stretcher board of the piano.

In some implementations, the main body of the stopper device is elastically deformable to accommodate movement between the open and closed configurations.

In some implementations, the main body further includes a hinge portion, wherein a first portion of the main body is pivotable about the hinge portion relative to a second portion of the main body.

In some implementations, an item space is defined between the fallboard and a stretcher board of the piano, the item space being in communication with the primary cavity of the piano when the fallboard transitions between the open and closed positions, wherein the stopper device separates the primary cavity of the piano from the item space such that an item falling behind the fallboard is caught by the stopper device before such item reaches a mechanical component of the primary cavity of the piano.

According to one implementation, an assembly is disclosed including a fallboard, a stretcher board, a pin block, and a stopper device. The fallboard for a piano includes a back end. The fallboard is movable between an open position and a closed position to reveal or conceal, respectively, a keyboard of the piano. The stretcher board extends longitudinally along the piano adjacent to the fallboard. The pin block extends longitudinally along the stretcher board. The stopper device includes a main body extending longitudinally along the piano. The main body includes a first end coupled to the back end of the fallboard and a second end coupled to one or both of the stretcher board and the pin block. The main body further includes an interior surface and an exterior surface opposed to the interior surface. The main body includes a flexible or foldable material.

In some implementations, the stopper device separates a primary cavity of the piano from an item space defined between the fallboard and the stretcher board, wherein the interior surface faces toward the primary cavity and the exterior surface faces towards the item space.

In some implementations, the stopper device is movable between an open configuration and a closed configuration, wherein, when moving between the open and closed configurations, the main body of the stopper device folds over itself to accommodate the changing orientation between the fallboard and the stretcher board and/or the pin block.

In some implementations, in the closed configuration, the exterior surface of the main body defines a pocket configured to retain an item therein.

In some implementations, the main body of the stopper device includes one or more of a fabric material and an elastic material configured to provide a soft close mechanism to the fallboard.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The systems, methods, and devices are explained in even greater detail in the following drawings. The drawings are merely exemplary, and certain features may be used singularly or in combination with other features. The drawings are not necessarily drawn to scale.

FIG. 1A is a diagram of a grand piano including particular external and internal features, according to one implementation.

FIG. 1B is an isometric view of a stopper device, according to one implementation.

FIG. 2 is a cross-sectional view of a stopper device coupled to a fallboard of a piano in the open configuration, according to one implementation.

FIG. 3 is a cross-sectional view of the stopper device and fallboard of FIG. 2 moving between the open and closed configurations.

FIG. 4 is a cross-sectional view of the stopper device and fallboard of FIG. 2 in the closed configuration.

FIG. 5 depicts a stopper device having a hinged channel, according to one implementation.

FIG. 6 shows another view of the stopper device of FIG. 5.

FIG. 7 shows a side view of the stopper device of FIG. 5.

FIG. 8 depicts a back side of a fallboard of a piano with the stopper device of FIG. 5 coupled thereto, according to one implementation.

FIG. 9 shows another view of the fallboard and stopper device of FIG. 8.

FIG. 10 shows another view of the fallboard and stopper device of FIG. 8.

FIG. 11 is a cross-sectional view of a stopper device coupled to a portion of a piano adjacent to the fallboard in the open configuration, according to one implementation.

FIG. 12 is a cross-sectional view of the stopper device and fallboard of FIG. 11 moving between the open and closed configurations.

FIG. 13 is a cross-sectional view of the stopper device and fallboard of FIG. 11 in the closed configuration.

FIG. 14 is a cross-sectional view of a stopper device coupled to a fallboard of a piano in the open configuration, according to one implementation.

FIG. 15 is a cross-sectional view of the stopper device and fallboard of FIG. 14 moving between the open and closed configurations.

FIG. 16 is a cross-sectional view of the stopper device and fallboard of FIG. 11 in the closed configuration.

Following below are more detailed descriptions of concepts related to, and implementations of, methods, apparatuses, and systems for a piano fallboard stopper. The figures illustrate exemplary implementations in detail, and the present disclosure is not limited to the details or methodology set forth in the description or illustrated in the figures. The terminology used herein is for the purpose of description only and should not be regarded as limiting.

### DETAILED DESCRIPTION

Disclosed herein is a device for blocking a gap where items can slide into a piano. In one example, a piano fallboard stopper is disclosed for blocking the gap where pencils or pens can slide/fall into the piano, particularly a grand piano. The disclosed device limits such items from falling into the piano in such a way that the user (e.g., the pianist) can grab the pencil or other item before the item interferes with the internal mechanisms (e.g., the action) of the piano. Furthermore, the disclosed device can also provide a soft-close mechanism for the piano.

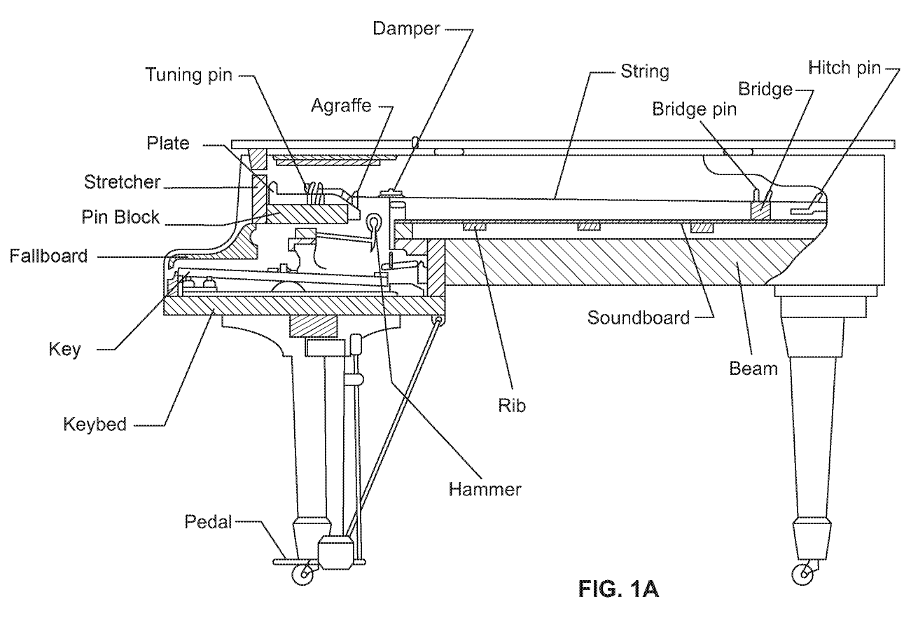

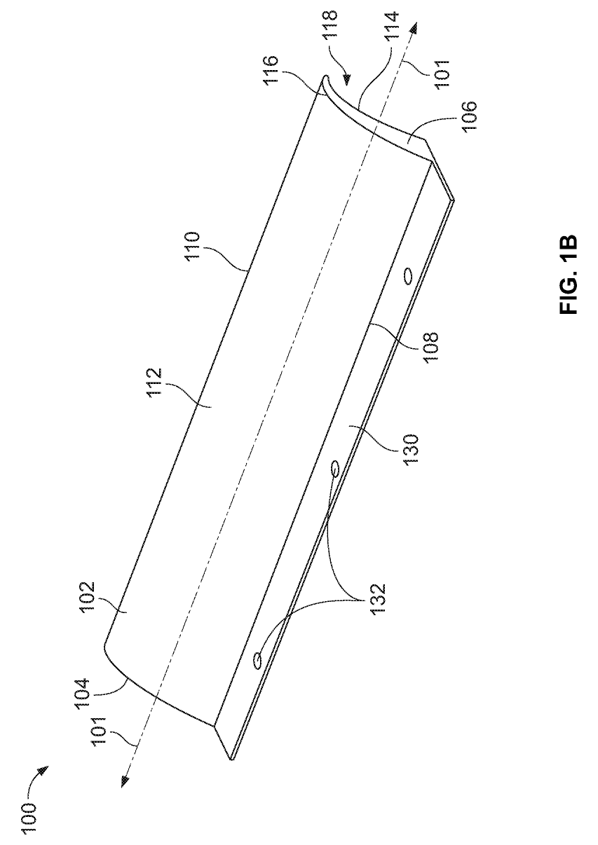

Grand piano fallboards are typically attached to the cheek blocks and cannot be easily removed by the customer. However, due to the design of grand piano fallboards, it is easy for pencils and other items to slide into the action of the piano. See, for example, FIG. 1A, showing a diagram of a grand piano, including the fallboard and the pin block. FIG. 1A is included to provide context to the location of the disclosed device within a piano. However, the disclosed device may be adapted to a different structure, geometry, or orientation of a piano, including pianos having structures different than that of FIG. 1A.

In some situations, if a pencil (or another handheld item) is balanced between the open fallboard and the stretcher board, the pencil will slide directly into the action of the piano if the fallboard begins to close. This happens frequently, and pianists often have no way of removing the fallboard to retrieve the pencil. The pencil should be retrieved, as the pencil (or other item) can cause a clicking/clunking sound when the keys are played, or worse, lead to broken parts in the action if the pencil becomes jammed in the action.

However, many pianos do not have fallboards that can be easily removed by the customer, so it can be costly to repeatedly call a piano technician to come out just to remove the fallboard and retrieve the pencil. Some pianists may leave the pencil in the piano until the next time the piano technician comes out to service the piano, but it is increasingly becoming an issue where pianists are losing more expensive items in the piano, such as electronic devices (e.g., headphones or digital pencils). Therefore, the disclosed device is installed in the piano to block or reduce the risk of items sliding into the piano (e.g., into a primary cavity of the piano having one or more active mechanisms). For example, the device may be installed inside of the piano in a way that it is not visible from the outside, but can block items from sliding in.

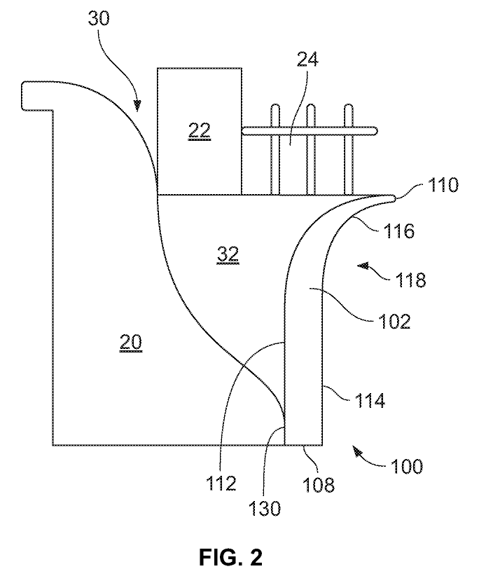

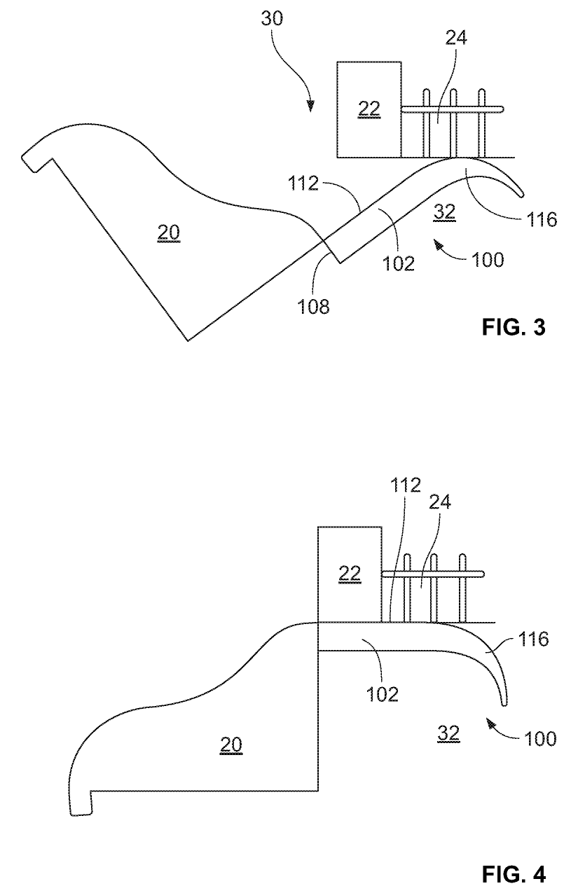

FIG. 1B shows a stopper 100 that is attachable to the bottom of the inside of the fallboard of a piano and blocks items from sliding into the piano. FIG. 2 shows a cross-sectional view of the stopper 100 of FIG. 1B attached to an open fallboard 20 of a piano with adjacent piano structures shown. FIGS. 3 and 4 show additional cross-sectional views of the disclosed stopper 100 in use on a piano. In particular, the stopper 100 is shown coupled to the fallboard 20 of a grand piano. The grand piano further includes a stretcher board 22 and a pin block 24, as shown in FIGS. 2-4.

As shown in FIG. 1B, the stopper 100 includes a main body 102 and a fastener strip 130. The main body 102 spans from a first body end 104 to a second body end 106 spaced apart from the first body end 104 along a longitudinal axis 101. The length of the stopper 100 is defined as the distance between the first body end 104 and the second body end 106. The length of the stopper 100 may be substantially equal to a length of the fallboard 20 of the piano. The overall dimensions of the stopper 100 (e.g., the width, length, and thickness) may be adjusted to fit a particular piano, type of piano, or customized geometry.

The main body 102 further includes a fixed body side 108 and a free end 110. The fixed body side 108 is spaced apart from the free end 110 in a direction substantially transverse to the longitudinal axis 101. The fixed body side 108 is configured to couple to a fastener strip 130, as further described herein.

The main body 102 further includes an upper body surface 112 and a lower body surface 114. The upper body surface 112 is spaced apart from, and opposed to, the lower body surface 114. Both the upper body surface 112 and the lower body surface 114 span from the first body end 104 to the second body end 106. As shown in FIGS. 2-4, the main body 102 has a substantially rectangular cross-sectional shape, particularly closer to the fixed body side 108. Thus, the upper body surface 112 and the lower body surface 114 are substantially parallel to each other for at least a portion of the main body 102.

The free end 110 of the main body 102 includes a curved tapered portion 116. The curved tapered portion 116 has a curved shape relative to the rest of the main body 102. For example, as shown in FIG. 2, the curved tapered portion 116 has a cross-sectional shape that deviates from the rectangular shape elsewhere on the main body 102. The curved tapered portion 116 has a thickness between the upper body surface 112 and the lower body surface 114 that gradually decreases in a direction from the fixed body side 108 toward the free end 110. The curved tapered portion 116 has a curvature such that the lower body surface 114 of the curved tapered portion 116 is concave to define a stopper cavity 118. The curved tapered portion 116 terminates in an edge along the free end 110 of the main body 102. Specifically, the upper body surface 112 and the lower body surface 114 converge at the free end 110 of the main body 102.

As is shown in FIG. 1B, the fastener strip 130 is coupled to the fixed body side 108 of the main body 102. The fastener strip 130 spans the length of the stopper 100 along the fixed body side 108 of the main body 102. However, in other implementations, the fastener strip may span one or more sections less than the entire length of the main body. The fastener strip 130 extends away from the fixed body side 108 in a direction substantially perpendicular to the upper body surface 112 of the main body 102.

The fastener strip 130 includes three holes 132 defined therethrough. The holes 132 provide a path and/or location for fasteners. For example, a screw or bolt can be inserted through each of the holes 132 to secure the fastener strip 130 and the stopper 100 to the open fallboard 20 of a piano. As shown in FIGS. 2-4, the fastener strip 130 is coupled to and aligned with the open fallboard 20 of the piano. In some implementations, the fastener strip 130 acts as a hinge about which the main body 102 can bend.

In other implementations, the fastener strip includes 1, 2, 4, 5, 6, 7, 8, 10 or more holes for fasteners, depending on the length of the device and the type of fasteners. In other implementations, the fastener strip includes a different type of fastener (e.g., a hook-and-loop fastener, a magnetic fastener, or an adhesive fastener) that is otherwise couplable to a corresponding portion of the fallboard.

The stopper 100 includes a semi-rigid and/or semi-flexible material, such as thermoplastic polyurethane (TPU), silicone, stiffened fabric, or slatted wood. A flexible material allows for the stopper 100 to be created as one piece, rather than multiple pieces (e.g., wherein the main body 102 and the fastener strip 130 are integrally formed). However, in some implementations, discrete elements are coupled and/or integrally formed together to define the stopper 100. The flexible material will also absorb the impact of an item hitting the stopper 100, so there will not be a loud noise when an item falls into the piano.

The stopper 100 is movable between a closed configuration and an open configuration. FIG. 2 shows the stopper 100 in an open configuration relative to the open fallboard 20, the stretcher board 22, and the pin block 24 of the piano. FIG. 3 shows the stopper 100 moving between the open and closed configurations. FIG. 4 shows the stopper 100 in the closed configuration relative to the closed fallboard 20, the stretcher board 22, and the pin block 24 of the piano.

In the open configuration of the fallboard 20, shown in FIG. 2, that the piano keys are accessible (i.e., a ready-to-play configuration). In the open configuration, an item space 30 is defined between the fallboard 20 and the stretcher board 22. The item space 30 is a common landing space for pencils, pens, and other items commonly used by a pianist or near a piano. In the open configuration, the stopper 100 is disposed within a primary cavity 32 of the piano, the primary cavity 32 being defined at least partially between the fallboard 20, the stretcher board 22 and the pin block 24.

In the open configuration, the stopper 100 and the longitudinal axis 101 thereof are arranged substantially perpendicularly to the stretcher board 22 and/or the pin block 24 of the piano. As shown in FIG. 2, the stopper 100 extends from a back side of the fallboard 20 in a substantially vertical direction. In particular, the fixed body side 108 of the main body 102 is adjacent to the back side of the fallboard 20, and the free end 110 with the curved tapered portion 116 abuts a portion of the pin block 24. The curved tapered portion 116 is arranged such that the upper body surface 112 of the curved tapered portion 116 (e.g., a convex portion) abuts the pin block 24. The upper body surface 112 of the main body 102 faces towards the fallboard 20, while the lower body surface 114 and the stopper cavity 118 defined by the lower body surface 114 is arranged further interior to the primary cavity 32 of the piano.

As shown in FIG. 3, when moving the fallboard 20 from the open to the closed position, the item space 30 between the fallboard 20 and the stretcher board 22 is suddenly expanded. In normal situations (e.g., without the disclosed stopper 100), items in the item space 30 would suddenly drop into the primary cavity 32 of the piano. However, when the stopper 100 moves from the open to the closed configuration, the free end 110 of the stopper 100 slides along the stretcher board 22 and the pin block 24, limiting access or communication between the item space 30 and the primary cavity 32. For example, the flexibility of the main body 102 helps to ensure that the free end 110 of the main body 102 abuts the stretcher board 22 and/or the pin block 24.

Furthermore, as the stopper 100 moves from the open to the closed configuration, the main body 102 hinges or bends relative to the fixed body side 108 and/or the fastener strip 130. For example, a portion of the fastener strip 130 and/or the fixed body side 108 is elastically deformable, allowing the main body 102 to bend or hinge relative to the fallboard 20.

In the closed configuration shown in FIG. 4, the fallboard 20 is closed (i.e., access to the keys of the piano is prevented). In the closed configuration, the stopper 100 and the longitudinal axis 101 thereof are arranged substantially parallel to the stretcher board 22 and/or the pin block 24 of the piano. The upper body surface 112 of the stopper 100 abuts the stretcher board 22 and/or the pin block 24. The stopper 100 is also fully disposed within the primary cavity 32 of the piano in the closed configuration such that the stopper 100 is not visible from the outside.

In the case that a pencil or other item was disposed in the item space 30 when the fallboard 20 was open, the item would drop onto the upper body surface 112 of the stopper 100 in the transition configuration shown in FIG. 3. Then, as the stopper 100 approached the closed configuration, the item would interfere with the fully closed position of the fallboard 20 and/or the stopper 100, indicating that a user should remove the item. One advantage is that the item would not fall into the primary cavity 32 of the piano and cause issues.

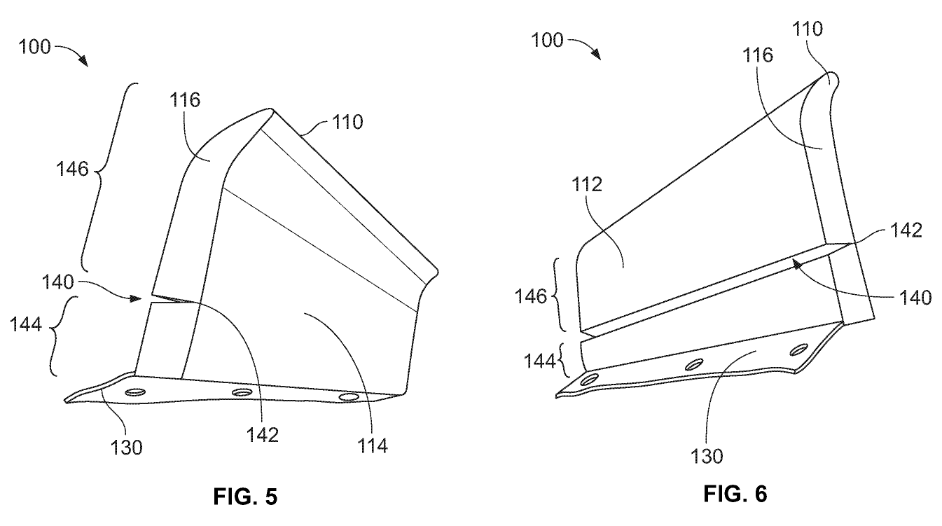

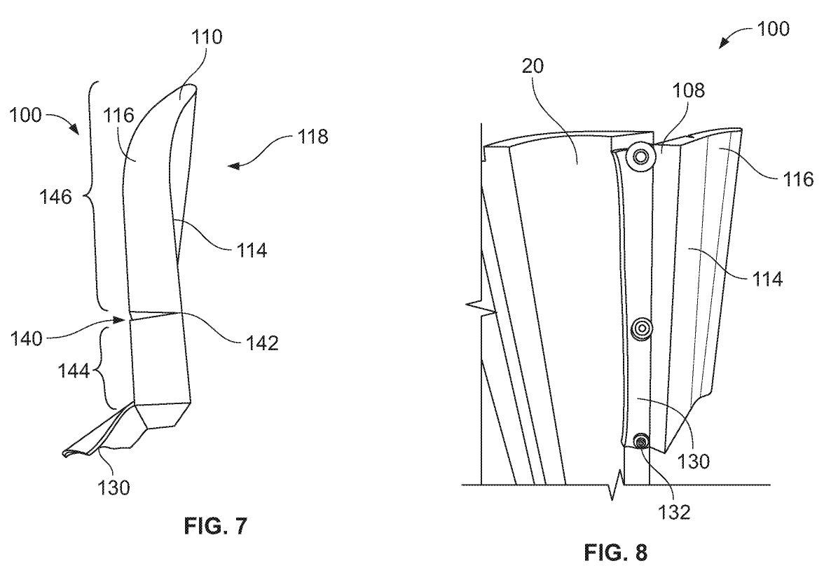

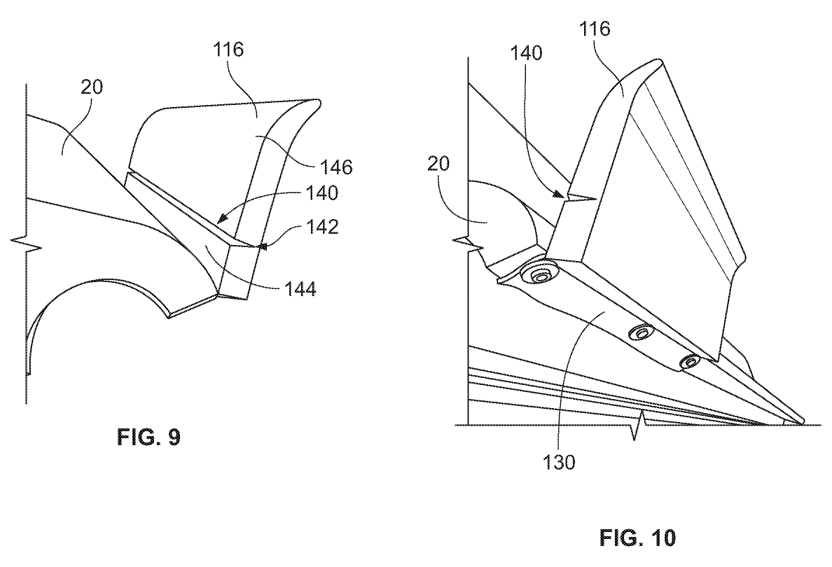

FIGS. 5-7 show a prototype implementation of the stopper 100, according to one implementation. FIGS. 8-10 show the prototype implementation of the stopper 100 coupled to a fallboard 20. The stopper 100 of FIGS. 5-10 is substantially similar in structure and function to the stopper 100 of FIGS. 1B-4, except as described below.

As shown in FIG. 5, the main body 102 of the stopper 100 defines a channel 140. The channel 140 extends from the upper body surface 112 towards, but not to, the lower body surface 114. In particular, the channel 140 includes an open end along the upper body surface 112. A hinge portion 142 is defined at the bottom of the channel 140 adjacent to the lower body surface 114. Thus, the channel 140 splits the main body 102 into a first portion 144 adjacent to the fixed body side 108 and a second portion 146 adjacent to the free end 110. The channel 140 and the hinge portion 142 allow for the first portion 144 to pivot or bend relative to the second portion 146 of the main body 102. To maintain blockage of the primary cavity 32, the channel 140 allows the stopper 100 to bend such that the second portion 146 bends inwards and the first portion 144 remains upright to catch any falling item.

For example, when the fallboard 20 and the stopper 100 are in the open configuration, the first portion 144 and the second portion 146 of the main body 102 are substantially parallel to each other. However, when moving towards and to the closed configuration, the second portion 146 can bend about the hinge portion 142. In the closed configuration, the first portion 144 and the second portion 146 may be substantially perpendicular to each other. In other configurations, the stopper includes a physical hinge, an elastic member, or another coupling feature between the first and second portions of the main body.

According to some implementations, the prototype implementation of the stopper 100 shown in FIGS. 5-10 is shorter than the stopper of FIGS. 1-4 so that the free end 110 does not touch the pin block 24 when the fallboard 20 is in the open position. According to some implementations, the height of the stopper 100 (e.g., from the fixed body side 108 to the free end 110) is sized and/or configured so that the stopper 100 does not hit the action of the piano before the fallboard 20 is fully closed.

According to some implementations, the stopper 100 of either FIGS. 1-4 or 5-10 provides a soft close mechanism for the piano. For example, the stopper 100 is configured to catch or rub against the pin block 24, slowing down the fallboard 20 as it closes.

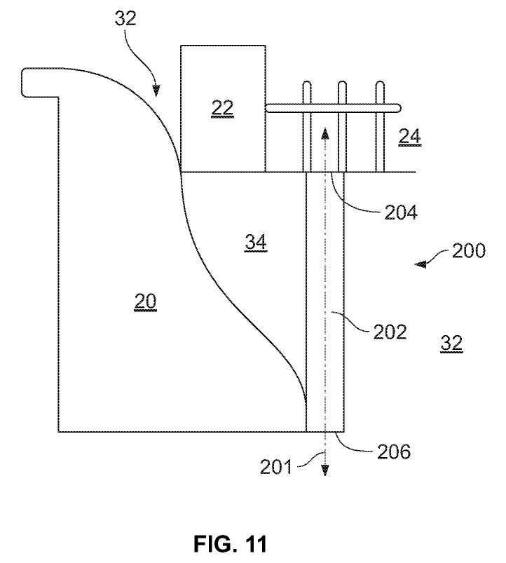

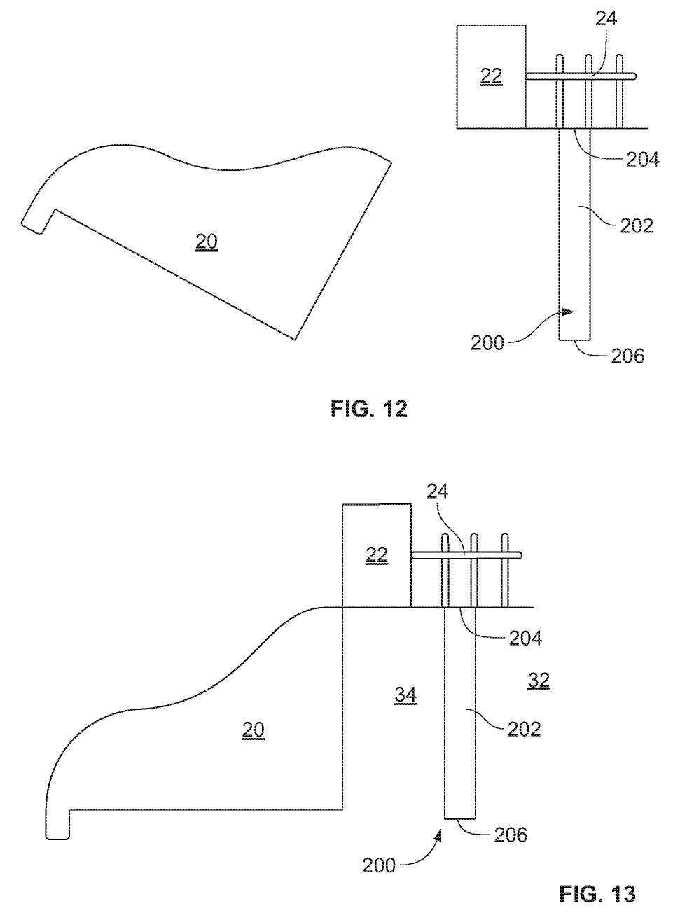

FIGS. 11-13 show another implementation of a stopper device for a piano, shown as stopper 200. It is understood that the exemplary implementations of the systems, methods, and devices disclosed herein include components or features that may be combined with or modified by other exemplary implementations of the present disclosure. Therefore, the features of the stopper 100 may be modified or combined with features of the stopper 200, or vice versa.

FIGS. 11-13 show cross-sectional views of the stopper 200 arranged relative to a fallboard 20, a stretcher board 22, and a pin block 24 of a piano. The stopper 200 includes a main body 202 spanning from a first end 204 to a second end 206 opposite and spaced apart from the first end 204 along a longitudinal axis 201.

The first end 204 of the main body 202 is coupled to the pin block 24. The main body 202 extends from the pin block 24 into the primary cavity 32 of the piano. In particular, the main body 202 and its longitudinal axis 201 are substantially perpendicular to the pin block 24 or a surface thereof. Thus, the second end 206 of the main body 202 is a free end disposed in the primary cavity 32 of the piano – behind the fallboard 20.

The stopper 200 remains stationary as the fallboard 20 opens or closes. As shown in FIGS. 10-13, the fallboard 20 moves between the open and closed positions. When the fallboard 20 is in the open position, shown in FIG. 11, the second end 206 of the stopper 200 abuts a back or top side of the fallboard 20. When the fallboard 20 is in the closed position, shown in FIG. 13, the stopper 200 is spaced apart from the fallboard 20.

The stopper 200 extends down from the pin block 24 to close or reduce the gap leading to the primary cavity 32 of the piano. In use, an item disposed in the item space 30 may fall into an initial space 34 defined between the fallboard 20 and the stopper 200. However, the item is hindered from falling further into the primary cavity 32 of the piano.

The stopper 200 provides at least one advantage in that an item falling through the item space 30 is limited from falling into the action of the piano. Thus, while the item may have fallen partially into the piano, the item can be retained in the initial space 34, which is isolated from the action of the piano. Thus, the stopper 200 reduces the risk of damage to the piano (e.g., the action or other mechanical parts of the piano).

The stopper 200 and its main body 202 are shown as having a rectangular cross-sectional shape. However, in other implementations, the main body of the stopper has a different shape and/or geometry accommodating the geometry of the piano. In some implementations, the main body of the stopper has a curvature, such as a curve directed towards the fallboard to catch or guide items towards the fallboard and away from the action of the piano.

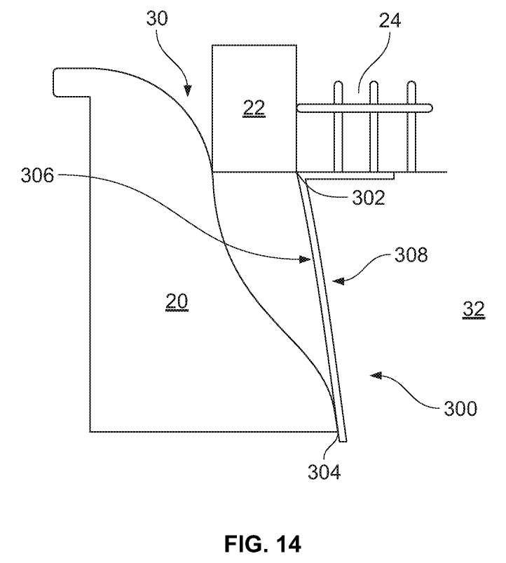

FIGS. 14-16 show another implementation of a stopper device for a piano, shown as stopper 300. It is understood that the exemplary implementations of the systems, methods, and devices disclosed herein include components or features that may be combined with or modified by other exemplary implementations of the present disclosure. Therefore, the features of the stopper 100 and/or stopper 200 may be modified or combined with features of the stopper 300, or vice versa.

The stopper 300 includes a flexible and/or foldable material (e.g., a fabric, a textile, a thin plastic, an elastomeric material, or a composite or more than one material). The stopper 300 is coupled on a first end 302 to an interface between the stretcher board 22 and the pin block 24. However, in other implementations, the first end of the stopper is coupled to the stretcher board 22, the pin block 24, or another portion of the piano adjacent thereto. The stopper 300 is coupled on a second end 304 to the back end of the fallboard 20. However, in other implementations, the stopper is coupled on the second end to another portion of the fallboard.

The stopper includes an exterior surface 306 and an interior surface 308. The exterior surface 306 faces towards the fallboard 20 and the item space 30. The interior surface 308 faces towards the primary cavity 32 of the piano. The stopper 300 spans across the length of the fallboard 20, similar to the stopper 100 shown in FIG. 1B. Thus, the stopper 300 effectively seals or separates the primary cavity 32 of the piano from the item space 30.

As shown in FIG. 14, when the fallboard 20 is in the open configuration, the stopper 300 is in an extended configuration (which may be considered an open configuration). The stopper 300 shown in FIG. 14 is arranged in a substantially vertical orientation between the back side of the fallboard 20 and the pin block 24. One or more portions of the stopper 300 may be folded or angled to accommodate the spacing and/or geometry to the piano components.

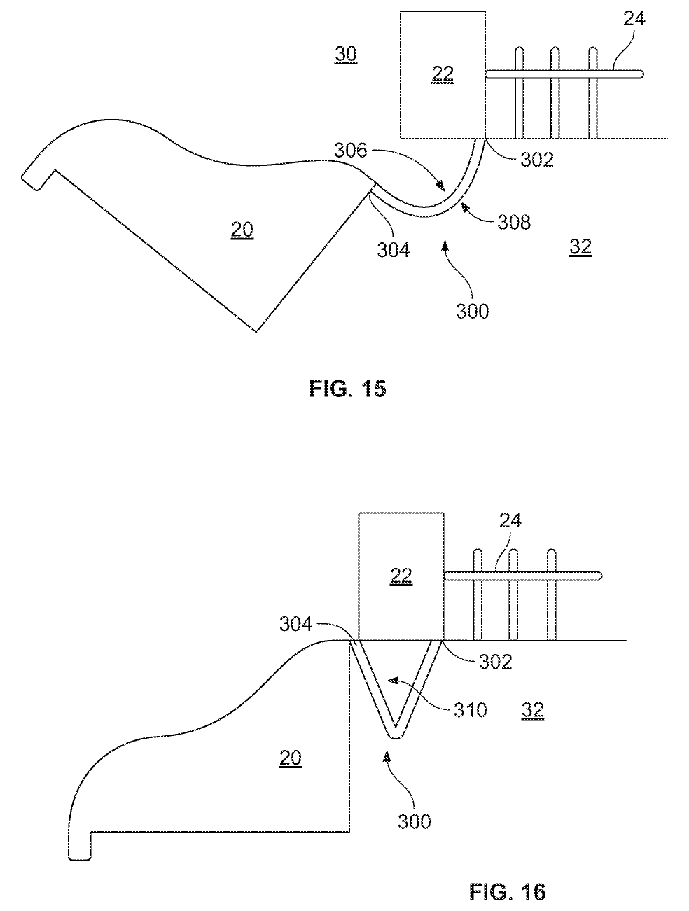

As shown in FIG. 15, when the fallboard 20 moves between the open and closed configurations, the first end 302 of the stopper 300 is pulled along with the fallboard 20 towards the item space 30 and/or the stretcher board 22. The stopper 300 flexes, folds, or otherwise changes its orientation to accommodate the movement while keeping the first end 302 and the second end 304 fixed to their respective coupling points. As seen in FIG. 15, the item space 30 and the primary cavity 32 are clearly separated by the stopper 300. A pencil or other item left in the item space 30 would fall into and be caught by the stopper 300.

As shown in FIG. 16, when the fallboard 20 is in the closed configuration, the stopper 300 is in a folded configuration (which may be considered a closed configuration). In the closed configuration, the first end 302 and the second end 304 of the stopper 300 are relatively close to one another. Thus, the stopper 300 folds back on itself. In the folded or closed configuration of the stopper 300, the exterior surface 306 defines a pocket 310 within which a pencil or other item can be retained. Any item falling into the stopper 300 is retained in the pocket 310 when the fallboard 20 is closed. The next time the piano is used and the fallboard 20 opened, the pencil or other item may be noticed by the user and removed from the stopper 300. In other cases, if the user does not notice the item, the item will remain in or adjacent to the item space 30, separated from the primary cavity 32. In other cases, opening the fallboard 20 may expel the item from the stopper 300 (e.g., due to the elastic nature of the stopper 300 material).

In some implementations, the material of the stopper 300 is a flexible material, such as fabric or cloth, that easily bends when the fallboard 20 opens and closes and is quite low-profile. A flexible but sturdier material such as thermoplastic polyurethane (TPU) or silicone could also be considered, the thickness of which can be adjusted for the piano’s geometry. In some implementations, a metal hinge is integrated into one or both ends of the stopper.

In some implementations, the material of the stopper 300 is a fabric and/or elastic material. In some implementations, the stopper 300 is biased towards the open configuration such that closing the fallboard 20 requires a minimum force. In such implementations, the stopper 300 is configured to provide a soft close mechanism for the fallboard, wherein the stopper 300 and the material thereof pulls on the fallboard 20 in a direction toward the open configuration.

Further disclosed herein is a method for hindering or preventing items from falling into a primary cavity of a piano. Such a method includes installing one or more of the disclosed stopper devices in a piano. For example, the stopper device is coupled to the fallboard via one or more fasteners. The method further includes opening and/or closing the fallboard of the piano such that the stopper device moves between the open and closed configurations. The method further includes capturing or redirecting, by the stopper device, an item falling into the primary cavity of the piano. The method may further include retrieving such item.

The disclosed stopper devices provide a grand piano fallboard stopper that may be a single-piece device that can be easily installed. The disclosed stopper devices limit or prevent items from falling into the piano, wherein the item can be retrieved by the pianist. The disclosed device may be manufactured easily, as it could be 3D printed out of thermoplastic polyurethane (TPU), cast out of silicone, injection molded, or any number of other common manufacturing techniques. These materials are also relatively inexpensive, which makes the cost of manufacturing lower and will make the cost for the customer lower. According to some implementations, the shape, structure, and material used in the disclosed stopper provide minimal impact on the sound of the piano. In other implementations, the stopper may intentionally absorb or dampen the sound.

The disclosed grand piano fallboard stopper is beneficial for pianists and piano technicians. The pianists benefit because they no longer need to worry about dropping items into the piano and can save money from having to repurchase the item they lost or calling a piano technician to retrieve the item. In particular, the disclosed device helps piano teachers, as students frequently drop pencils into the piano. It is also beneficial for college practice rooms, as many college students drop pencils, digital devices, and other items into the pianos. The piano technician benefits from knowing that pencils will not jam the action and break action parts.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A stopper device for a piano fallboard, the stopper device comprising:
a main body spanning between a first body end to a second body end spaced apart from the first body end along a longitudinal axis, the main body comprising:
a fixed body side;
a free end spaced apart from the fixed body side in a direction transverse to the longitudinal axis; and
a curved tapered portion including the free end of the main body; and
a fastener strip extending from the fixed body side of the main body, the fastener strip being couplable to a fallboard of a piano.

2. The stopper device of claim 1, wherein a length of the main body is defined between the first body end and the second body end, the length of the main body being configured to extend across a length of the fallboard of the piano.

3. The stopper device of claim 1, wherein the main body further comprises an upper body surface and a lower body surface opposed to the upper body surface, wherein a thickness of the main body is defined between the upper body surface and the lower body surface.

4. The stopper device of claim 3, wherein the curved tapered portion comprises a thickness less than that of a remainder of the main body.

5. The stopper device of claim 3, wherein the curved tapered portion terminates in an edge at which the upper body surface converges with the lower body surface.

6. The stopper device of claim 3, wherein the lower body surface of the curved tapered portion is concave to define a stopper cavity.

7. The stopper device of claim 1, wherein the main body comprises a flexible material capable of elastic deformation.

8. The stopper device of claim 1, further comprising a channel defined along a length of the main body adjacent to the fixed body side, the channel splitting the main body into a first portion and a second portion coupled to each other via a hinge portion such that the first portion of the main body is moveable about the hinge portion relative to the second portion of the main body.

9. The stopper device of claim 1, wherein the fastener strip defines one or more holes configured to receive a fastener.

10. An assembly comprising:
a fallboard for a piano comprising a back end, the fallboard being movable between an open position and a closed position to reveal or conceal, respectively, a keyboard of the piano; and
a stopper device comprising:
a fastener strip coupled to the back end of the fallboard;
a main body spanning a length of the fallboard in a longitudinal direction, the main body comprising:
a fixed body side coupled to the fastener strip;
a free end spaced apart from the fixed body side in a direction transverse to the longitudinal direction; and
a curved tapered portion including the free end of the main body,
wherein, when the fallboard moves between the open and closed positions, the stopper device moves between an open configuration and a closed configuration, respectively, such that the stopper device separates a primary cavity of the piano from an exterior of the piano to hinder objects from falling into the primary cavity behind the fallboard.

11. The assembly of claim 10, wherein, in the open configuration of the fallboard, the main body of the stopper device is disposed within the primary cavity of the piano, wherein the free end of the main body abuts a stretcher board or a pin block of the piano such that the main body is substantially perpendicular to the stretcher board or the pin block.

12. The assembly of claim 10, wherein, when moving the fallboard between the open and closed positions and the stopper device between the corresponding open and closed configurations, the curved tapered portion of the stopper device slides along a pin block and/or a stretcher board of the piano.

13. The assembly of claim 12, wherein the main body of the stopper device is elastically deformable to accommodate movement between the open and closed configurations.

14. The assembly of claim 12, wherein the main body further comprises a hinge portion, wherein a first portion of the main body is pivotable about the hinge portion relative to a second portion of the main body.

15. The assembly of claim 10, wherein an item space is defined between the fallboard and a stretcher board of the piano, the item space being in communication with the primary cavity of the piano when the fallboard transitions between the open and closed positions,
wherein the stopper device separates the primary cavity of the piano from the item space such that an item falling behind the fallboard is caught by the stopper device before such item reaches a mechanical component of the primary cavity of the piano.

16. An assembly comprising:
a fallboard for a piano comprising a back end, the fallboard being movable between an open position and a closed position to reveal or conceal, respectively, a keyboard of the piano;
a stretcher board extending longitudinally along the piano adjacent to the fallboard;
a pin block extending longitudinally along the stretcher board; and
a stopper device comprising:
a main body extending longitudinally along the piano, the main body comprising:
a first end coupled to the back end of the fallboard;
a second end coupled to one or both of the stretcher board and the pin block;
an interior surface; and
an exterior surface opposed to the interior surface,
wherein the main body comprises a flexible or foldable material.

17. The assembly of claim 16, wherein the stopper device separates a primary cavity of the piano from an item space defined between the fallboard and the stretcher board, wherein the interior surface faces toward the primary cavity and the exterior surface faces towards the item space.

18. The assembly of claim 16, wherein the stopper device is movable between an open configuration and a closed configuration, wherein, when moving between the open and closed configurations, the main body of the stopper device folds over itself to accommodate the changing orientation between the fallboard and the stretcher board and/or the pin block.

19. The assembly of claim 18, wherein, in the closed configuration, the exterior surface of the main body defines a pocket configured to retain an item therein.

20. The assembly of claim 16, wherein the main body of the stopper device comprises one or more of a fabric material and an elastic material configured to provide a soft close mechanism to the fallboard.
